(19) United States
(12) Patent Application Publication
(10) Pub. No.: US 2007/0261998 A1
(43) Pub. Date: Nov. 15, 2007

(54) Modified polysaccharides for depressing floatable gangue minerals

(76) Inventor: Philip Crane, Sunbury (AU)

Correspondence Address: COGNIS CORPORATION;PATENT DEPARTMENT, 300 BROOKSIDE AVENUE, AMBLER, PA, 19002, US

(21) Appl. No.: 11/799,521

(22) Filed: May 2, 2007

Related U.S. Application Data
(60) Provisional application No. 60/797,597, filed on May 4, 2006.

(51) Int. Cl. B03D 1/14

(52) U.S. Cl. 209/167

(57) ABSTRACT

A class of non-sulfide, silicate gangue material depressants based on naturally-occurring galactomannans, having a galactose-to-mannose ratio of less than 1:2.1, exemplified by modified products of the seed gums: casia tora gum, sesbania gum, kalonji gum, Ceratonia siliqua gum and/or Tamarindus indica gum, and methods of making and using them.

### CROSS-REFERENCE TO RELATED APPLICATIONS

This application claims priority under 35 U.S.C. §119(e) from provisional U.S. Patent Application No. 60/797,597, filed on May 4, 2006, the entire contents of which are incorporated herein by reference.

### BACKGROUND OF THE INVENTION

1. Field of the Invention

This invention relates to the froth flotation process used in base and precious metals mining operations to selectively collect valuable minerals into a floating, high-grade concentrate, containing greatly-reduced amounts of undesirable contaminants, and separated from those unwanted contaminants, which are rendered nonfloating through the use of “depressing reagents” or “depressants” that are selectively adsorbed onto the surfaces of the contaminants.

2. Background and Related Art

The separation of particles of desired minerals from the unwanted “gangue materials” with which these desired minerals are intimately mixed in their ores often takes the form of froth flotation, where concentrates of the valuable minerals float in a froth of air bubbles on an aqueous pulp slurry that also contains unwanted, sometimes deleterious impurities, that could interfere with and/or increase the cost of the subsequent metallurgical and/or chemical processing operations where the final metal elements may be realized and/or reduce the value of the ultimate product.

Froth flotation involves adding to the aqueous slurry of fine ore particles “collectors”, which selectively modify the surfaces of the finely ground particles containing the desired mineral(s), which are to be floated, rendering them hydrophobic, and enabling them to become attached to air bubbles that rise to the surface of the pulp, “frothers”, generally water-insoluble materials that promote foaming by reducing the surface tension of the water, “depressants”, which selectively modify the surfaces of gangue particles, rendering them hydrophilic and preventing or inhibiting their adsorption on collectors, and reducing their natural flotation or their tendency to become attached to rising air bubbles, as well as possibly other conditioning or modifying agents that aid in the flotation and concentration of valued minerals and separation of these valued minerals form the unwanted gangue materials.

In valued and precious metals flotation, certain gangue materials present a problem in that they float independently of the valued mineral collectors used. Even when very selective valued mineral collectors are used, these gangue materials often end up in the concentrates, increasing the weight of the concentrates, adding to handling and transporting costs, and diluting the valued minerals content in the concentrate, thereby either reducing the overall valued minerals recovery or making the concentrates less suitable, or in some cases, unsuitable for further processing to recover the desired metal values.

The use of depressing reagents or depressants to prevent the flotation of gangue minerals and low-assay middlings is well known. U.S. Pat. No. 3,371,778 (Iwasaki), for example, discusses the use of a solution of a gelatinized starch that has been subjected to a violent shearing action as a depressant for siliceous gangue materials in the froth flotation of oxidized iron ores and U.S. Pat. No. 4,274,951 (Goold) relates to the addition of guar gum ethers to a mineral ore pulp in order to improve the separation of calcite and other gangue minerals from apatite ores in phosphate mining operations. U.S. Pat. No. 4,220,525 (Petrovich) describes the use of polyhydroxy amine depressants for silica, silicates, carbonates, sulfates, phosphates and other acidic gangue materials for a froth flotation procedure that may possibly provide for a selective separation of two or more valuable minerals, and U.S. Pat. No. 4,360,425 (Lim et al) proposes the use of low molecular weight synthetic copolymers or terpolymers of nonionic and anionic monomers, or water soluble salts thereof, which are not susceptible to bacterial decomposition, optionally mixed with naturally-derived depressants, for depressing nonsulfide and do not result in the flocculation of the depressed mineral values in a slurry of a non-sulfide mineral, such as iron, potash or phosphate ores. U.S. Pat. No. 4,902,764 (Rothenberg et al) relates to the use of polyacrylamide-based copolymers and terpolymers as depressants for sulfide mineral recovery.

U.S. Pat. No. 4,952,329 (Bulatovic et al) provides depressants comprising quebracho, modified with guar gum or dextrin, with a water-soluble salt of lignin sulfonate and one or more specific inorganic reagents for use in froth flotation of polymetallic sulfide ores and U.S. Pat. No. 4,853,114 (Lewis et al) relates to the use of hemicellulose as a selective depressant for hydrous, layered silicates, such as talc (magnesium silicate), in the froth flotation of various valuable and precious minerals. U.S. Pat. No. 5,030,340 (Panzer et al) describes the use of dihydroxyalkyl polysaccharides as selective depressants for hydrous, layered silicates from valued minerals or metals from sulfide ores and U.S. Pat. No. 5,011,596 (Shaw) discusses the use of bacterial cellulose as a depressant for readily-floatable silicate minerals in an ore flotation process. U.S. Pat. No. 5,533,626 (Nagaraj et al) relates to the use of a polymeric mixture of polysaccharide and acrylamides. A general discussion of some of the complexity of the flotation process and depressants for it is contained in Crane, “Depressants for Control of Naturally Floatable Gangue Minerals in Sulphide Mineral Flotation”, Oretest Colloquium, April, 1998. Other references to the flotation process and examples of depressants for it exist.

The selection of the appropriate depressant is complicated, in that depressants known to be capable of depressing certain gangue materials may not be useful for other gangue, for example, depressants known to be capable of suppressing the floatability of sulfide minerals are not known to be depressants for non-sulfide minerals, just as known valued sulfide collectors are usually not good collectors for non-sulfide valued minerals. Different minerals may have vastly different bulk and surface chemical properties, and may have responses to different chemicals that are vastly different.

Certain polysaccharides, such as guar gum (a galactomannan gum having a mannose-to-galactose ratio of less than or equal to 2:1) and carboxymethyl cellulose, are used to depress non-sulfide, silicate gangue minerals during valued and precious sulfide metals flotation. Performance of these depressants may vary considerably, even evidencing unacceptable depressant activity, and their use may be subject to availability and price, due to source and competing use considerations. There remains an urgent need for flotation reagents that can selectively depress non-value silicates that may end up in valued mineral flotation concentrates and concurrently provide economically-acceptable grades and recoveries and of valued minerals.

A new class of non-sulfide silicate gangue mineral depressants has been discovered that is based on natural galactomannans having a mannose-to-galactose ratio of greater than 2.1:1. Examples of these galactomannans are products of one or more of the seed gums: casia tora gum, sesbania gum, kalonji gum, Ceratonia siliqua gum and/or Tamarindus indica gum.

### BRIEF SUMMARY OF THE INVENTION

This invention relates to the manufacture of novel polysaccharide depressants which can be employed for suppressing the floatability of gangue minerals (hereinafter, understood to refer to “non-sulfide, silicate” gangue mineral) in order to improve the grade and recovery of the desired mineral specie(s), as well as to the application of these depressants to depress silicates in the flotation of PGM (platinum group metal)-, nickel- and gold-bearing sulfide ores. The present invention further relates to a froth flotation process for the recovery of mineral values from base and precious metal ores, more particularly, to a new and improved process for beneficiating minerals by froth flotation incorporating the new group of depressants.

### DETAILED DESCRIPTION OF THE INVENTION

The gangue mineral depressants of the invention comprise modified naturally-occurring glactomannan having a galactose-to-mannose ratio of less than 1:2.1 and a degree of carboxy methyl substitution of from about 0.05-to-about 0.5, and a 10% solution thereof in deionized (“DI”) water, at 20° C. and 20 rpm, has a viscosity of from 500-to-15,000 cps, as measured on a Brookfield Viscometer, two hours after preparation of the solution. Preferred galactomannans are products of the seed gums casia tora gum, sesbania gum, kalonji gum, Ceratonia siliqua gum and/or Tamarindus indica gum, with the galactomannans from casia tora gum particularly preferred. Preferably, the galactose-to-mannose ratio of the galactomannans is between 1:2.1 and 1:10, and more preferably between 1:3 and 1:7, with galactomannans having a galactose-to-mannose ratio of 2:11 being most preferred. It is well understood in the art that a natural galactomannan product, even when from one source, has a range of galactose-to-mannose ratios, and the ratios given are generally average ratios. Additionally, the galactose-to-mannose ratio will vary in a given galactomannan-producing species depending on environmental and genetic mutation factors (including mutations from plant breeding).

The gangue mineral depressants of the invention preferably have a degree of carboxy methyl substitution of from about 0.1-to-about 0.3, and most preferably of about 0.2. The viscosities of 10% solutions thereof in deionized water at 20° C. at 20 rpm is preferably from about 750-to-about 11,000, and more preferably from about 2,000-to-about 6,000, as measured using a Brookfield Viscometer, two hours after preparation of the solution. The gangue mineral depressants of the invention preferably disperse and hydrate in cold water (about 20° C.).

Accordingly, in a first aspect, the present invention provides a gangue material depressant comprising a modified, naturally-occurring glactomannan having a galactose-to-mannose ratio of less than 1:2.1, and a degree of carboxy methyl substitution of from about 0.05 to about 0.5, and a 10% solution thereof in deionized water, at 20° C. and 20 rpm, has a viscosity of from about 500-to-about 15,000 cps, as measured on a Brookfield Viscometer two hours after preparation of the solution thereof.

In a second aspect, the invention provides a gangue material depressant comprising a modified, naturally-occurring glactomannan, having a galactose-to-mannose ratio of less than 1:2.1, and obtainable by a process comprising:

(a) reacting a naturally-occurring galactomannan, according to the invention, with sodium monochloroacetate (“SMCA”) in the presence of a strong base, in order to obtain a degree of carboxy methyl substitution of from about 0.05 to about 0.5;

(b) reacting the resulting carboxy methyl-substituted product with a solution of hydrogen peroxide in water, in order to partially depolymerize the galactomannan structure;

(c) neutralizing the resulting partially-depolymerized product with a strong acid; and

(d) recovering the resulting modified, naturally-occurring glactomannan product in solid form,

wherein the depolymerization of step (b) results in the reconstituted product having a viscosity of from about 500-to-about 15,000 cps, as measured with a 10% solution in deionized water at 20° C. and 20 rpm, on a Brookfield Viscometer two hours after preparation of the solution.

In a third aspect, the invention provides a gangue material depressant comprising a modified, naturally-occurring glactomannan, having a galactose-to-mannose ratio of less than 1:2.1, and obtainable by a process comprising:

(a) reacting a naturally-occurring galactomannan, according to the invention, with sodium monochloroacetate in the presence of a strong base in order to obtain a degree of carboxy methyl substitution of from about 0.05 to about 0.5;

(b) neutralizing the resulting carboxy methyl-substituted reaction product with a strong acid;

(c) reacting the resulting neutralized product with a mixture of sodium nitrite and sodium metabisulfite;

(d) reacting the resulting product with a solution of hydrogen peroxide in water; and

(e) recovering the resulting modified, naturally-occurring glactomannan product in solid form,

wherein the reconstituted product of step (d) has a viscosity of from 500-15,000 cps, as measured with a 10% solution in deionized water at 20° C. and 20 rpm, on a Brookfield Viscometer two hours after preparation of the solution.

In a fourth aspect, the present invention provides a process for producing a gangue material depressant comprising a modified, naturally-occurring glactomannan having a galactose-to-mannose ratio of less than 1:2.1, the process comprising:

(a) reacting a naturally-occurring galactomannan, according to the invention, having a galactose-to-mannose ratio of less than 1:2.1, with sodium monochloroacetate, in the presence of a strong base, in order to obtain a degree of carboxy methyl substitution of from about 0.05 to about 0.5;

(b) reacting the resulting carboxy methyl-substituted product with a solution of hydrogen peroxide in water, in order to partially depolymerize the galactomannan structure;

(c) neutralizing the resulting partially-depolymerized product with a strong acid; and

(d) recovering the resulting modified, naturally-occurring glactomannan product in solid form,

wherein the depolymerization of step (b) results in the reconstituted product having a viscosity of from about 500-to-about 15,000 cps, as measured with a 10% solution in deionized water at 20° C. and 20 rpm, on a Brookfield Viscometer two hours after preparation.

In a fifth aspect, the present invention provides a process for producing a gangue material depressant comprising a modified, naturally-occurring glactomannan having a galactose-to-mannose ratio of less than 1:2.1, the process comprising:

(a) reacting a naturally-occurring galactomannan according to the invention, having a galactose-to-mannose ratio of less than 1:2.1 with sodium monochloroacetate, in the presence of a strong base, in order to obtain a degree of carboxy methyl substitution of from about 0.05-to-about 0.5;

(b) neutralizing the resulting carboxy methyl-substituted reaction product with a strong acid;

(c) reacting the resulting neutralized product with a mixture of sodium nitrite and sodium metabisulfite;

(d) reacting the resulting product with a solution of hydrogen peroxide in water; and

(d) recovering the resulting modified, naturally-occurring glactomannan product in solid form,

wherein the reconstituted product of step (d) has a viscosity of from about 500-to-about 15,000 cps, as measured with a 10% solution in deionized water at 20° C. and 20 rpm, on a Brookfield Viscometer two hours after preparation.

In a sixth aspect, the invention provides a method of depressing a floatable gangue material in a froth flotation process of particles of an ore containing the material and at least one valued mineral, which method comprises subjecting an aqueous mineral pulp of said ground ore to froth flotation in the presence, inter alia, of a sufficient amount of a non-sulfide garigue material depressant comprising a modified, naturally-occurring glactomannan, having a galactose-to-mannose ratio of less than 1:2.1, a degree of carboxy methyl substitution of from about 0.05-to-about 0.5, and a viscosity of from about 500-to-about 15,000 cps, as measured with a 10% solution in deionized water at 20° C. and 20 rpm, on a Brookfield Viscometer two hours after preparation, to depress the readily-floatable, non-sulfide gangue material into the flotation tailings and recovering the at least one valued mineral in the froth.

In the process according to the second and fourth aspects of the invention, the degree of carboxy methyl substitution to be achieved in step (a) is preferably about 0.1 to about 0.3, and most preferably about 0.2. In step (a), the weight ratio of the SMCA-to-lye (sodium hydroxide) is preferably between about 0.9:1 and about 1.1:1. The weight ratio of SMCA to the galactomannan splits is preferably from about 1:10 to about 1:1.5, more preferably from about 1:7.5 to about 1:2.5, most preferably about 1:4.5 to about 1:5.5. The strong base in step (a) is preferably selected from the group consisting of caustic soda lye, sodium hydroxide, potassium hydroxide, sodium carbonate, potassium carbonate and a mixture of two or more thereof; and more preferably is caustic soda lye or sodium hydroxide. The reaction in step (a) is preferably carried out at a temperature of about 65° C.-to-about 85° C. The strong acid in step (c) is preferably selected from the group consisting of sulfuric acid, phosphoric acid, hydrochloric acid, and acetic acid, of which sulfuric acid is particularly preferred. The reaction in step (b) is preferably carried out at a temperature of less than about 98° C.

In the process according to the third and fifth aspects of the invention, the degree of carboxy methyl substitution to be achieved in step (a) is preferably from about 0.1-to-about 0.3, and most preferably about 0.2. The strong base in step (a) is preferably selected from the group consisting of caustic soda lye, sodium hydroxide, potassium hydroxide, sodium carbonate, potassium carbonate and a mixture of two or more thereof—more preferably is caustic soda lye or sodium hydroxide. The reaction in step (a) is preferably carried out at a temperature of about 65° C.-to-about 85° C. The strong acid in step (b) is preferably selected from the group consisting of sulfuric acid, phosphoric acid, hydrochloric acid, and acetic acid, of which sulfuric acid is particularly preferred. In step (c), the corresponding potassium or lithium salts may be used in place of sodium salts. The reaction in step (d) is preferably carried out at temperatures below about 92′-to-about 98° C.

As stated above, the sixth aspect of the invention concerns a method of depressing a floatable non-sulfide gangue material(s) in a froth flotation process of an ore containing the gangue material(s) and at least one valued mineral, which method comprises subjecting an aqueous mineral pulp of particles of said ore to froth flotation in the presence of a sufficient amount of, inter alia, a non-sulfide gangue material depressant. That depressant comprises a modified naturally-occurring glactomannan, having a galactose-to-mannose ratio of less than 1:2.1, a degree of carboxy methyl substitution of from about 0.05-to-about 0.5, and a viscosity of from about 500-to-about 15,000 cps, as measured with a 10% solution thereof in deionized water at 20° C. and 20 rpm, on a Brookfield Viscometer, two hours after preparation, in order to depress the readily-floatable silicate minerals into the flotation tailings, then subsequently recovering the one or more valued minerals from the ore in the froth. The preferred and more preferred non-sulfide gangue mineral depressants for use in this method are the same as those stated above with respect to the first aspect of the invention, namely, for the modified naturally-occurring galactomannans, according to the instant invention. The valued metals sought to be recovered by the flotation separation process are generally one or more of nickel, copper, zinc, gold and/or platinum group metals (PGM's). In this flotation process, the modified naturally-occurring galactomannan depressants of the invention will generally be applied at about 10-to-about 1,000 grams per ton of ground ore treated, more preferably at about 50-to-about 200 grams per ton. For nickel, the preferred amount is from about 50-to-about 750 grams per ton of ground ore treated. For the PGM's, the preferred amount is about 50-to-about 300 grams per ton of ore treated. The practitioner skilled in the art will understand that these amounts may vary greatly depending on the particular type and amount of non-sulfide gangue material to be separated from the particular type of valued metal(s) ores encountered in the ore deposit. The art-skilled person will also understand that the non-sulfide gangue mineral depressants of the invention may be selectively employed at one or more stages of the flotation process.

For packing purposes, appropriate amounts of anti-bacterial, pH control and flow improvement materials may be mixed with the modified galactomannan powder of the invention. These materials may include, for example, PN beads (SPCP) and ketjensil (silica) or soda ash.

The following Examples are intended to exemplify the instant invention, without, in any way, limiting it.

### EXAMPLE 1

### Preparation of Gangue Mineral Depressant from Casia Tora Gum (without the Sodium Nitrite/Sodium Metabisulfite Reaction)

A reaction vessel was charged with 25 Kg of casia tora splits, a galactomannan having a 2/11 galactose to mannose ratio. In a separate container, 5.0 Kg of caustic soda lye in 12.5 L of water and 5.0 Kg of sodium monochloroacetate (SMCA) in 12.5 L of water were mixed. The resulting SMCA mixture was pumped into the reaction vessel. The temperature of the galactomannan/SMCA mixture in the reaction vessel was then increased to 74-76° C. over an hour and maintained there for an additional hour. In a separate container, 850 gm of hydrogen peroxide was dissolved in 1 L of water and then stirred at room temperatures for two hours. Thereafter, the hydrogen peroxide solution was pumped into the galactomannan/SMCA reaction mixture. The resulting reaction was allowed to proceed until the temperature rose to 92° C. Thereafter, the reaction mixture was cooled to room temperature, and the resulting solution was neutralized with a solution of 625 gm of sulfuric acid in 2 L of water. The resulting solid modified galactomannan product was milled to provide a powder of the modified galactomannan product. The powder had a moisture content of 8.2%, a pH of 6.65 (in deionized water) and a viscosity of 4800 (as measured using a Brookfield Viscometer with a 10% solution of the product in deionized water at 20° C. and 20 rpm, two hours after preparation of the solution).

### EXAMPLE 2

### Preparation of Gangue Mineral Depressant from Casia Tora Gum (Including the Sodium Nitrite/Sodium Metabisulphite Reaction)

A reaction vessel was charged with 25 Kg of casia tora splits, a galactomannan having a 2/11 galactose-to-mannose ratio. In a separate container, 5.0 Kg of caustic soda lye in 12.5 L of water and 5.0 Kg of sodium monochloroacetate (“SMCA”) in 12.5 L of water were mixed, and the resulting SMCA mixture was pumped into the reaction vessel. The temperature of the SMCA mixture in the reaction vessel was increased to 74-76° C. over an hour and maintained there for an additional hour. 850 gm of hydrogen peroxide was dissolved in 1 L of water and stirred, at room temperature, for two hours, in a separate container, then pumped into the galactomannan/SMCA mixture, and the resulting reaction was allowed to proceed until the temperature had risen to 92° C. The reaction mixture was cooled to room temperature, and the resulting solution was neutralized with a solution of 625 gm of sulfuric acid in 2 L of water, and the resulting solid modified galactomannan product was milled to a powder, which was then charged to a reaction vessel. Separately, 125 gm of sodium nitrite was dissolved in 2.4 L of water and then added to a separately-prepared 392 gm of sodium metabisulfite that had been dissolved in 7.5 L of water, and this combination was mixed thoroughly. The resulting sodium nitrite/metabisulfite mixture was pumped, over 20 to 30 minutes, into the reaction vessel containing the SMCA-modified galactomannan powder, and twenty-thirty minutes later, 850 gm of hydrogen peroxide that had been separately dissolved in 1 L of water was pumped into the SMCA reaction mixture. The resulting reaction was allowed to proceed until the temperature rose to 92-94° C., whereupon the resulting solid modified galactomannan product was recovered and milled to provide a powder of the modified galactomannan product. The powder had a moisture content of 8.4%, a pH of 6.89 (in deionized water), and a 10% solution thereof in deionized water at 20° C. and 20 rpm had a viscosity of 2300 (as measured with a Brookfield Viscometer two hours after preparation of the solution).

### EXAMPLE 3

### Flotation Process with and without Depressant of the Invention

1000 parts of a crushed ore containing about 0.2% nickel, 5 parts/metric ton of platinum group metals and gold, and considerable talc was ground in a rod mill with 500 parts of tap water and 25 parts/ton of 1% copper sulfate (1% solution in water) for 60 minutes in order to achieve a grind of about 70% of particles passing 74 microns. The ground slurry was transferred to a suitable stainless steel Denver flotation cell and the water level made up with tap water. Forty parts/ton of sodium isobutyl xanthate (1% solution in water) was added and the slurry was agitated using a Denver D12 mechanism at 900 rpm for two minutes. Forty parts/ton of n-butyl dithiophosphate (1% solution in water) was added and agitation is continued for another two minutes. At this stage, the depressant was added as a 1% solution in water, at a dosage of 100 grams per ton of ore, immediately followed by a standard volume of frother with another two minutes of agitation. (Everything else was the same, but the depressant was omitted in the NIL run.) Air was then applied to the cell and a flotation concentrate collected for three minutes, after which a second concentrate was collected for seven minutes, and a third concentrate was collected for fifteen minutes. Concentrates and tailings were filtered, dried and assayed for platinum group metals and gold, with the recovery and grade being calculated from the weights and assays.

The results are set forth in Table I below, where IX is a modified galactomannan of the invention from Example 1, and NIL represents a zero depressant dosage for comparison.

TABLE I

| | | | |
|---|---|---|---|
| | | Cumulative | Cumulative |
| wt % | PGM, g/t | grade g/t | % Recovery |

IX

| | | | | |
|---|---|---|---|---|
| C1 | 2.46 | 125.9 | 125.9 | 58.6 |
| C2 | 3.05 | 36.0 | 76.1 | 79.4 |
| C3 | 2.80 | 9.3 | 53.6 | 84.4 |
| Tails | 91.69 | 0.9 | | 100.0 |
| heads | | 5.3 | | |

NIL

| | | | | |
|---|---|---|---|---|
| C1 | 3.12 | 93.7 | 93.7 | 56.0 |
| C2 | 3.36 | 33.9 | 62.7 | 77.8 |
| C3 | 2.72 | 9.1 | 46.8 | 82.6 |
| Tails | 90.80 | 1.0 | | 100.0 |
| heads | | 5.2 | | |

As can be readily appreciated from the Cumulative % Recovery and the Cumulative Grade g/t columns, a significantly higher platinum group metal recovery was achieved with the modified galactomannan depressant of the invention, including a significantly higher overall grade, than is the case without depressant of the invention.

### EXAMPLE 4

### Flotation Process with and without Depressant of the Invention

1000 parts of crushed ore containing about 0.2% nickel, 5 parts/metric ton of platinum group metals and gold and considerable talc was ground in a rod mill with 500 parts of tap water and 25 parts/ton of 1% copper sulfate (1% solution in water) for 60 minutes to achieve a grind of about 70% passing 74 microns. The ground slurry was transferred to a suitable stainless steel Denver flotation cell and the water level made up with tap water. Forty parts/ton of sodium isobutyl xanthate (1% solution in water) was added and the slurry agitated using a Denver D12 mechanism at 900 rpm for two minutes. Forty parts/ton of n-butyl dithiophosphate (1% solution in water) was added and agitation continued for another two minutes. At this stage, depressant was added as a 1% solution in water, at a dosage of 100 grams per ton of ore, immediately followed by a standard volume of frother with another two minutes of agitation. (Everything else was the same, but the depressant was omitted in the NIL run.). Air was then applied to the cell, and a flotation concentrate was collected for three minutes, after which a second concentrate was collected for seven minutes, and a third concentrate was collected for fifteen minutes. Concentrates and tailings were filtered, dried and assayed for platinum group metals and gold, with the recovery and grade being calculated from the weights and assays. The results are set forth in Table II below, where IX is a modified galactomannan of the invention from Example 2, and NIL represents a zero depressant dosage for comparison.

TABLE II

| | | | |
|---|---|---|---|
| | | Cumulative | Cumulative |
| wt % | PGM, g/t | Grade g/t | % Recovery |

IX

| | | | | |
|---|---|---|---|---|
| C1 | 2.53 | 123.4 | 123.4 | 60.1 |
| C2 | 3.16 | 31.8 | 72.5 | 79.4 |
| C3 | 2.94 | 8.3 | 50.6 | 84.1 |
| Tails | 91.38 | 0.9 | | 100.0 |
| heads | | 5.2 | | |

NIL

| | | | | |
|---|---|---|---|---|
| C1 | 3.12 | 93.7 | 93.7 | 56.0 |
| C2 | 3.36 | 33.9 | 62.7 | 77.8 |
| C3 | 2.72 | 9.1 | 46.8 | 82.6 |
| Tails | 90.80 | 1.0 | | 100.0 |
| heads | | 5.2 | | |

As can be readily appreciated from the Cumulative % Recovery and the Cumulative Grade g/t columns, a significantly higher platinum group metal recovery was achieved with the modified galactomannan depressant of the invention, including a significantly higher overall grade, than is the case without depressant of the invention.

What is claimed is:

1. A gangue mineral depressant comprising a modified naturally-occurring glactomannan, having a galactose-to-mannose ratio of less than 1:2.1, and a degree of carboxy methyl substitution of from about 0.05-to-about 0.5, and a viscosity of a 10% solution thereof in deionized water at 20° C. and 20 rpm of from 500-to-15,000 cps, as measured with a Brookfield Viscometer two hours after preparation of the solution thereof.

2. The gangue mineral depressant according to claim 1, wherein the naturally-occurring galactomannan is derived from cassia tora gum, sesbania gum, or kalonji gum.

3. The gangue mineral depressant according to claim 1, wherein the naturally-occurring galactomannan is derived from cassia tora gum.

4. The gangue mineral depressant according to claim 1, wherein the galactose-to-mannose ratio is between 1:2.1 and about 1:10.

5. The gangue mineral depressant according to claim 1, wherein the galactose-to-mannose ratio is between about 1:3 and about 1:7.

6. The gangue mineral depressant according to claim 1, wherein the galactose-to-mannose ratio is about 2:11.

7. The gangue mineral depressant according to claim 1, wherein the degree of carboxy methyl substitution in the depressant is from about 0.1-to-about 0.3.

8. The gangue mineral depressant according to claim 1, wherein the measured viscosity of a 10% solution of the depressant is from 750-to-11,000 cps.

9. The gangue mineral depressant according to claim 1, which disperses and hydrates in cold water.

10. A gangue mineral depressant comprising a modified naturally-occurring glactomannan having a galactose-to-mannose ratio of less than 1:2.1 and obtainable by a process comprising:
(a) reacting a naturally-occurring galactomannan with sodium monochloroacetate, in the presence of a strong base, in order to obtain a carboxy methyl-substituted product, having a degree of carboxy methyl substitution of from about 0.05-to-about 0.5;
(b) reacting the resulting carboxy methyl-substituted product with a solution of hydrogen peroxide in water in order to partially depolymerize the galactomannan structure, resulting in a partially-depolymerized product;
(c) neutralizing the partially-depolymerized product with a strong acid, resulting in a modified naturally-occurring galactomannan; and
(d) recovering the modified naturally-occurring glactomannan product in solid form,
wherein, upon reconstitution with deionized water, a 10% solution of the modified glactomannan product in that deionized water, at 20° C. and 20 rpm, has a viscosity of from about 500-to-about 15,000 cps, as measured with a Brookfield Viscometer two hours after preparation of the solution.

11. The gangue mineral depressant according to claim 10, wherein the naturally-occurring galactomannan is derived from cassia tora gum, sesbania gum, or kalonji gum.

12. The gangue mineral depressant according to claim 10, wherein the naturally-occurring galactomannan is derived from cassia tora gum.

13. The gangue mineral depressant according to claim 10, wherein the galactose-to-mannose ratio is between 1:2.1 and about 1:10.

14. The gangue mineral depressant according to claim 10, wherein the strong base in step (a) is selected from the group consisting of caustic soda lye, sodium hydroxide, potassium hydroxide, sodium carbonate, potassium carbonate and a mixture of two or more thereof.

15. The gangue mineral depressant according to claim 10, wherein the strong base in step (a) is caustic soda lye or sodium hydroxide.

16. The gangue mineral depressant according to claim 10, wherein the reaction in step (a) is carried out at a temperature of from about 65° C.-to-about 85° C.

17. The gangue mineral depressant according to claim 10, wherein the degree of carboxy methyl substitution in step (a) is from about 0.1-to-about 0.3.

18. The gangue mineral depressant according to claim 10, wherein the strong acid in step (c) is selected from the group consisting of sulfuric acid, phosphoric acid, hydrochloric acid, and acetic acid.

19. The gangue mineral depressant according to claim 10, wherein the strong acid in step (c) is sulfuric acid.

20. The gangue mineral depressant according to claim 10, wherein the reaction in step (b) is carried out at a temperature of less than 98° C.

21. The gangue mineral depressant according to claim 10, wherein the viscosity of a 10% solution of the reconstituted product in deionized water is from about 750-to-about 11,000 cps.

22. A gangue mineral depressant comprising a modified naturally-occurring glactomannan, having a galactose-to-mannose ratio of less than 1:2.1, and obtainable by a process comprising:
(a) reacting a naturally-occurring galactomannan with sodium monochloroacetate, in the presence of a strong base, in order to obtain a carboxy methyl-substituted reaction product with a degree of carboxy methyl substitution of from about 0.05-to-about 0.5;
(b) neutralizing the carboxy methyl-substituted reaction product with a strong acid to produce a neutralized product;
(c) reacting the neutralized product with a mixture of sodium nitrite, potassium nitrite, or lithium nitrite, and sodium metabisulfite, potassium metabisulfite or lithium metabisulfite;
(d) reacting the product of step (c) with a solution of hydrogen peroxide in water, to produce a modified naturally-occurring glactomannan product; and
(e) recovering the resulting modified naturally-occurring glactomannan product in solid form,
wherein, upon reconstitution of the glactomannan product from step (d) with deionized water, a 10% solution of that product in deionized water at 20° C. and 20 rpm, has a viscosity of from 500-15,000 cps, as measured with a Brookfield Viscometer, two hours after preparation thereof.

23. The gangue mineral depressant according to claim 22, wherein the naturally-occurring galactomannan is derived from cassia tora gum, sesbania gum, or kalonji gum.

24. The gangue mineral depressant according to claim 22, wherein the naturally-occurring galactomannan is derived from cassia tora gum.

25. The gangue mineral depressant according to claim 22, wherein the galactose-to-mannose ratio is between 1:2.1 and about 1:10.

26. The gangue mineral depressant according to claim 22, wherein the strong base in step (a) is selected from the group consisting of caustic soda lye, sodium hydroxide, potassium hydroxide, sodium carbonate, potassium carbonate and a mixture thereof.

27. The gangue mineral depressant according to claim 22, wherein the strong base in step (a) is caustic soda lye or sodium hydroxide.

28. The gangue mineral depressant according to claim 22, wherein the reaction in step (a) is carried out at a temperature of about 65° C.-to-about 85° C.

29. The gangue mineral depressant according to claim 22, wherein the degree of carboxy methyl substitution in step (a) is from about 0.1 to about 0.3.

30. The gangue mineral depressant according to claim 22, wherein the reaction in step (d) is carried out until the temperature reaches about 92′-to-about 98° C.

31. The gangue mineral depressant according to claim 22, wherein the viscosity of the reconstituted product of step (e) is from about 750-to-about 11,000 cps.

32. A method of depressing a floatable gangue material in a froth flotation process of an ore containing the floatable non-sulfide gangue material and one or more valued minerals, which method comprises subjecting an aqueous mineral pulp of particles of said ore to froth flotation in the presence of a sufficient amount of a gangue mineral depressant comprising a modified, naturally-occurring glactomannan, having a galactose-to-mannose ratio of less than 1:2.1, and a degree of carboxy methyl substitution of from about 0.05 to about 0.5, and a viscosity of a 10% solution of the gangue mineral depressant in deionized water at 20° C. and 20 rpm of from 500-15,000 cps, as measured on a Brookfield Viscometer two hours after preparation of the depressant, to depress the readily-floatable gangue material into flotation tailings in the pulp and recovering one or more one valued minerals from the froth.
